(19) United States
(12) Patent Application Publication
(10) Pub. No.: US 2019/0170274 A1
(43) Pub. Date: Jun. 6, 2019

(54) RETRACTABLE WIRING SUPPORT FOR A MOTOR VEHICLE

(71) Applicant: Ford Global Technologies, LLC, Dearborn, MI (US)

(72) Inventors: Eduardo Arturo Aguilar Ruelas, Mexico City (MX); Hendryk Felipe Campos Cardenas, Agricola Pantitlan (MX)

(21) Appl. No.: 15/832,353

(22) Filed: Dec. 5, 2017

(51) Int. Cl. F16L 3/233; F16L 3/12; F16L 3/137; F16L 3/237; H01R 13/60; H01R 13/72

(52) U.S. Cl. CPC F16L 3/233; F16L 3/1215; H01R 13/72; F16L 3/237; H01R 13/60; F16L 3/137

(57) ABSTRACT

An apparatus includes a housing and a wiring support carried on the housing. The wiring support is displaceable between a home position, retracted in the housing and a deployed positon for holding a charge cable or other wiring.

### TECHNICAL FIELD

This document relates generally to the motor vehicle equipment field and, more particularly, to an apparatus incorporating a retractable wiring support that may be deployed to hold a wire such as a USB cable in a desired out-of-the-way position where it will not interfere with the operation of other motor vehicle systems, will not distract the driver and will help to maintain a neater and more organized passenger compartment.

### BACKGROUND

Electronic devices such as smart phones, music players and navigation devices are commonly operated and placed at accessible positions in a motor vehicle when traveling from place to place. Often, these devices are connected via a USB cable or other charging cord to a utility outlet of the motor vehicle adapted to share information with motor vehicle components (such as an information screen) or charge such electronic devices during use. Typically the cords are much longer than required to reach from the utility outlet to the electronic device and the cord may become tangled amongst the parking brake lever, gear shift lever, cup holders and other features provided on a center console of the motor vehicle. This can become a significant annoyance and distraction to the driver.

This document relates to a new and improved apparatus for managing a charge cord. That apparatus includes a retractable wiring support that may be deployed to hold the charge cord or cable in a desired position where it is out of the way and is rendered neither an annoyance nor a distraction to the motor vehicle operator.

### SUMMARY

In accordance with the purposes and benefits described herein, a new and improved apparatus is provided. That apparatus comprises a housing and a wiring support carried on the housing. The wiring support is displaceable between a home position and a deployed position.

The apparatus may further include a biasing element that biases the wiring support toward the deployed position. The wiring support may include a base and a clip carried on the base. The clip may be connected to the base by a pin. The pin may be carried on the clip and received in a socket carried on the base. Together, the pin and the socket allow the clip to be rotated with respect to the base so that the wiring support may be oriented about an arc of 360 degrees thereby enabling it to be conveniently positioned for holding a charge cable or other wire associated with an electronic device that might be used during operation of the motor vehicle. The housing may further include a bezel.

A guide feature may be provided on the housing. That guide feature functions as a guide for the wiring support as the wiring support is displaced between the home position and the deployed position. The guide feature may include a guide track carried on the housing as well as a cooperating guide track follower. The guide track follower may include a link arm having a first end and a second end. The first end of the link arm may be pivotally connected to the wiring support by a pivot pin. The second end of the link arm may hold a guide track pin that is received by and follows the guide track.

The guide track may be continuous. In one or more embodiments, the guide track may include six sides and six vertices. In one or more embodiments, the guide track may be chevron shaped. Further, the guide track may include a first peak and a second peak. The guide track pin may be positioned at the first peak when the wiring support is in the home position. The guide track pin may be positioned in the second peak when the wiring support is in the deployed position.

In the following description, there are shown and described several preferred embodiments the apparatus. As it should be realized, the apparatus is capable of other, different embodiments and its several details are capable of modification in various, obvious aspects all without departing from the apparatus as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and together with the description serve to explain certain principles thereof.

FIG. 1a is an exploded view showing the various components of the apparatus including the housing and the wiring support carried on the housing.

FIG. 1b is a detailed, exploded perspective view of the wiring support including the base and the clip that is connected to the base.

FIG. 2a is a detailed perspective view of the assembled apparatus showing the wiring support in the retracted or home position.

FIG. 2b is a detailed perspective view similar to FIG. 2a but showing the wiring support in the deployed position.

FIG. 2c is another detailed perspective view of the apparatus illustrating how the clip may be rotated through an arc of 360 degrees to allow adjustment of the orientation of the clip opening to accommodate the holding of a charge cable or other wire;

FIG. 2d is an illustration of a charge cable held in the clip of the wiring support.

FIG. 3 is an elevational view of a center console, incorporating two of the apparatus illustrated in FIG. 1 holding and managing a charge cable extending from a utility outlet of a motor vehicle to an electronic device held in a pocket on the center console.

FIG. 4 is a detailed perspective view illustrating how one apparatus may be mounted in a cooperating receiver provided in a trim panel of the center console.

FIGS. 5a-5c is a series of views illustrating how the wiring support is displaced from the deployed position to a home position. More particularly, FIG. 5a is a perspective view illustrating the wiring support in the deployed position. FIG. 5b illustrates the orientation of the guide feature when the wiring support is in the deployed position. FIG. 5c illustrates the orientation of the guide feature when the wiring support is transitioning from the deployed position to the home position.

FIGS. 6a-6c are a series of views illustrating the displacement of the wiring support from the home position to the deployed position. More specifically, FIG. 6a is a perspective view illustrating the wiring support in the home position (biasing element removed to show other structures more clearly). FIG. 6b is a detailed illustration of the orientation of the guide feature when the wiring support is in the home position. FIG. 6c is an illustration of the guide feature when the wiring support is transitioning from the home position to the deployed position.

Reference will now be made in detail to the present preferred embodiments of the apparatus, examples of which are illustrated in the accompanying drawing figures.

### DETAILED DESCRIPTION

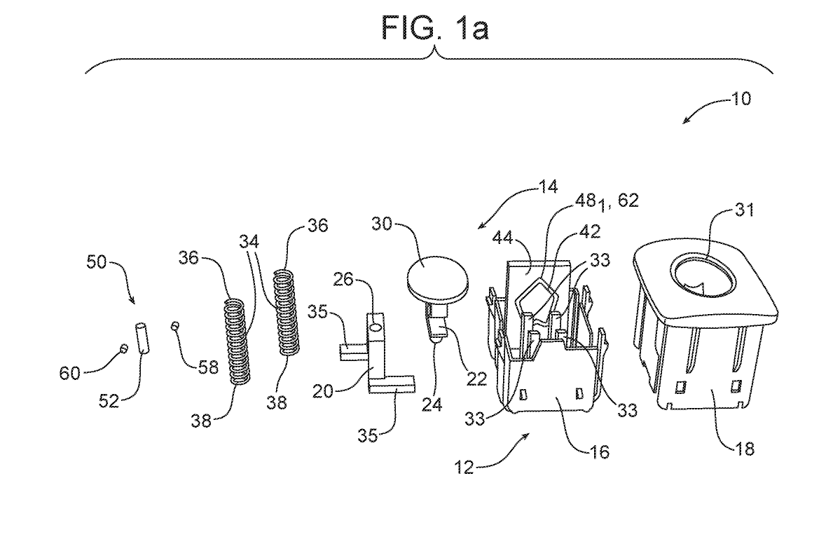

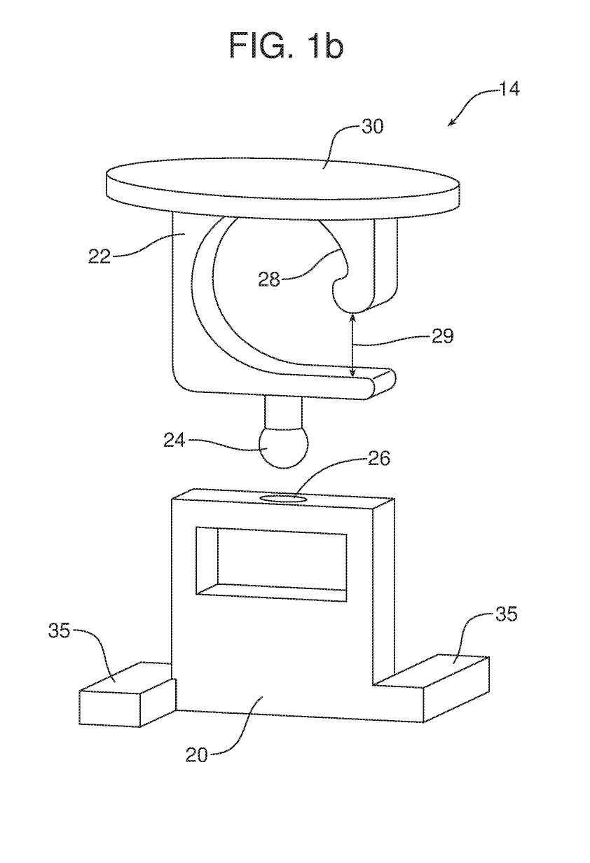

Reference is now made to drawing FIGS. 1a, 1b, 2a-2d, 3, 4, 5a-5c and 6a-6c which illustrate the new and improved apparatus 10 that is adapted to manage a charge cord C and, more particularly, hold the charge cord in a desired position so as to better organize the passenger compartment of the motor vehicle and maintain the charge cord out of the way where it will not be an annoyance or a distraction to the driver when operating the motor vehicle.

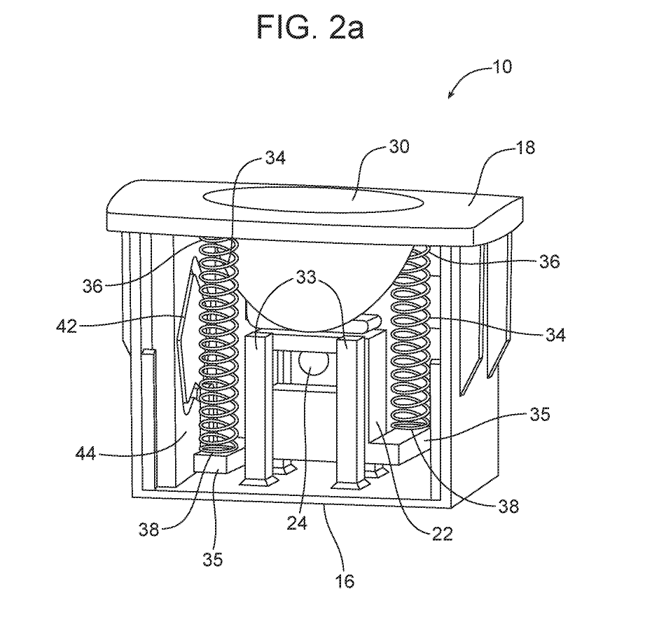

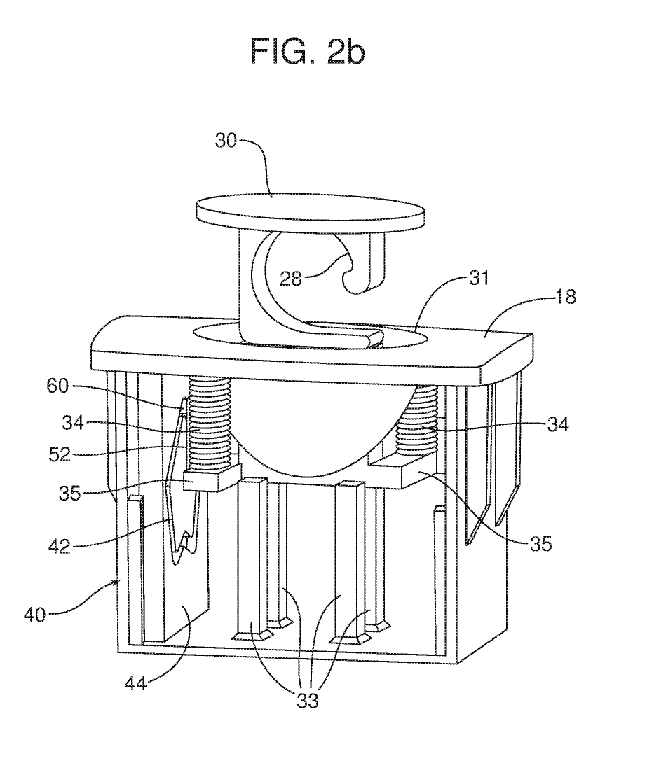

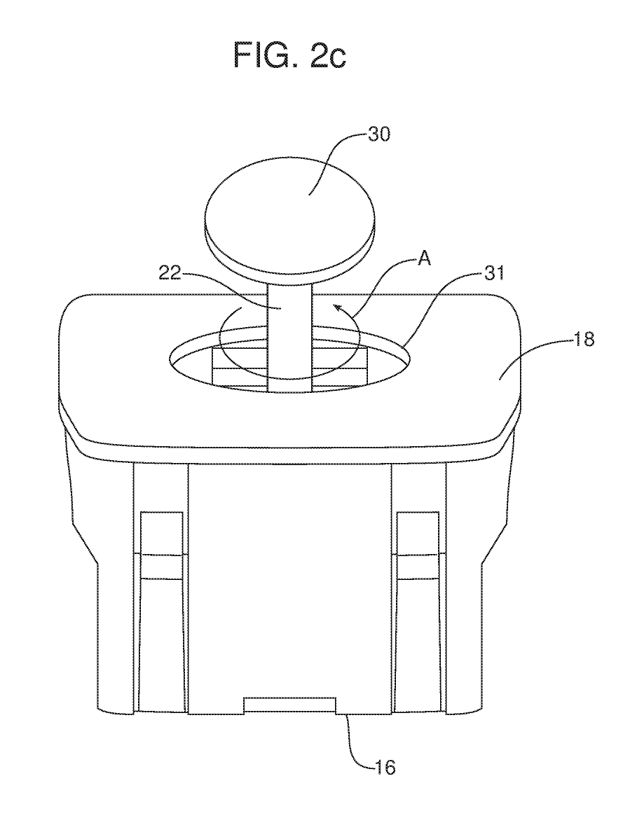

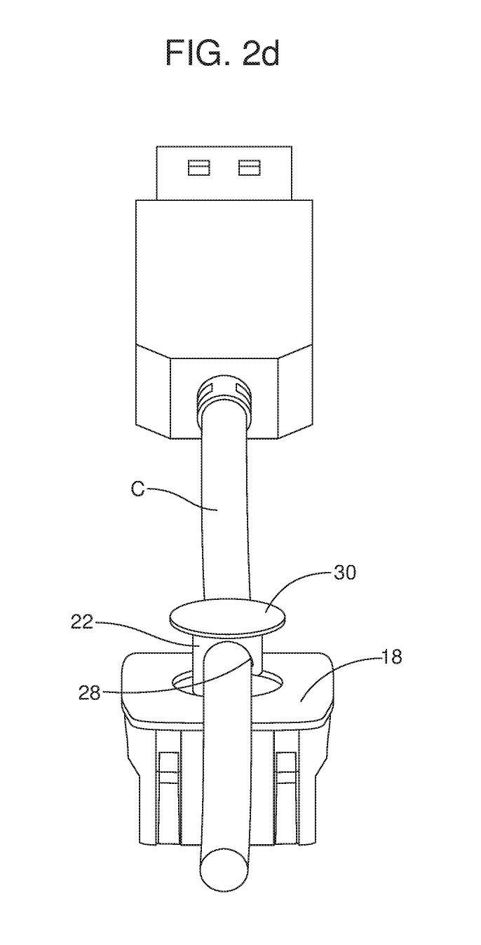

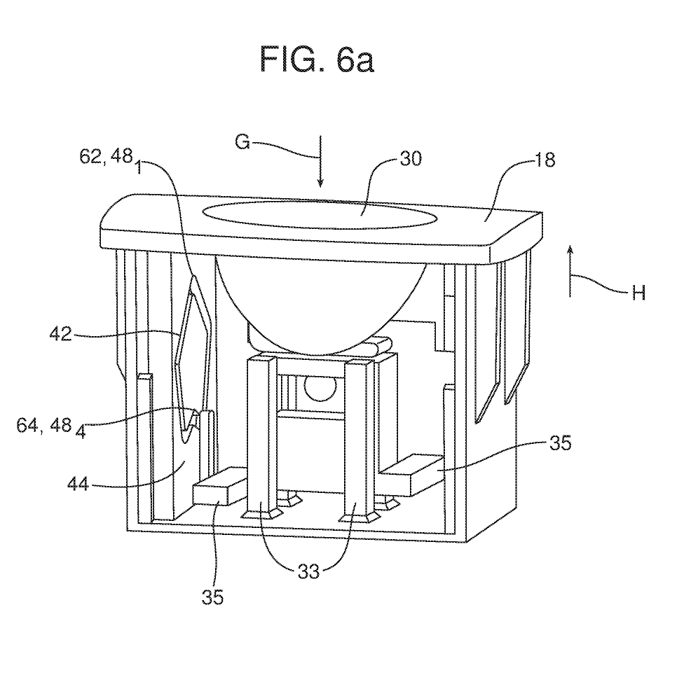

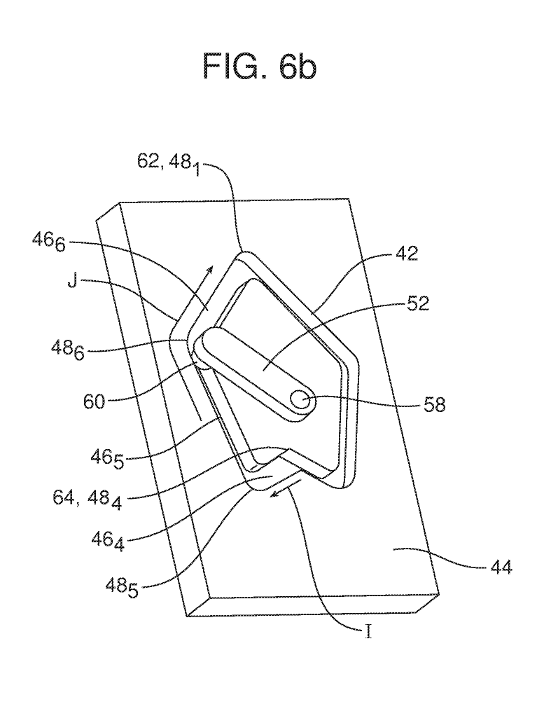

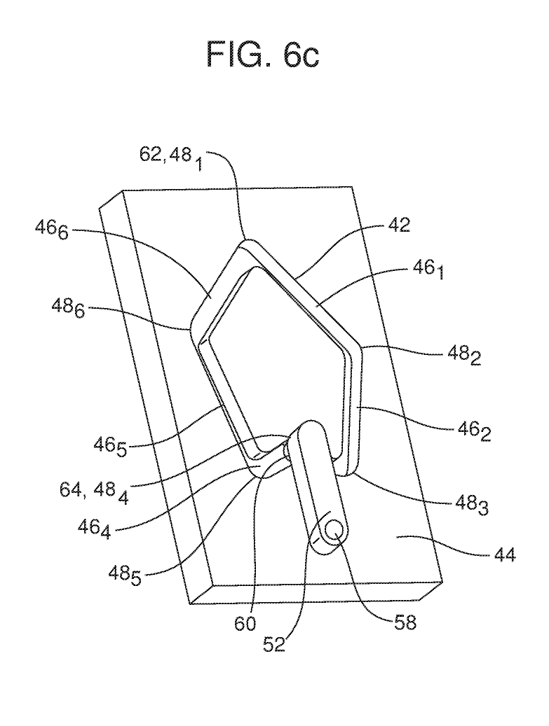

As best illustrated in FIG. 1a, the apparatus 10 includes a housing 12 and a wiring support 14. The wiring support 14 is carried on the housing 12 and is displaceable between a home position illustrated in FIGS. 2a and 6a and a deployed position illustrated in FIGS. 2b, 2c, 3, 4 and 5a.

More specifically, the housing 12 includes a main body 16 and an overlying bezel 18. As illustrated in FIGS. 1a and 1b, the wiring support 14 includes a base 20 and a clip 22 carried on the base. More specifically, the clip 22 is connected to the base 20 by a pin 24 that is carried on the clip and received in a socket 26 carried on the base. As illustrated in FIG. 2c, the pin 24 and socket 26 function together to allow the clip 22 to be rotated with respect to the base 20 through a full arc of 360 degrees (note action arrow A) thereby allowing the wire receiving aperture 28 provided in the clip 22 beneath the head 30 to be oriented as desired to receive the charge cable C through the pass-through or neck 29 of the receiving aperture. Four spaced guide posts 33, carried on the main body 16, engage the side edges and the wings 35 of the base 20 to maintain the base in proper alignment in the main body 16 as the clip 22 is twisted in the base and the wiring support 14 is displaced between the home and the deployed positions.

A biasing element 34 biases the wiring support 14 toward the deployed position. In the illustrated embodiment, the biasing element 34 comprises a pair of tension springs, each having a first end 36 fixed to the bezel 18 and a second end 38 fixed to the base 20 of the wiring support 14. See, for example, FIGS. 1a and 2a.

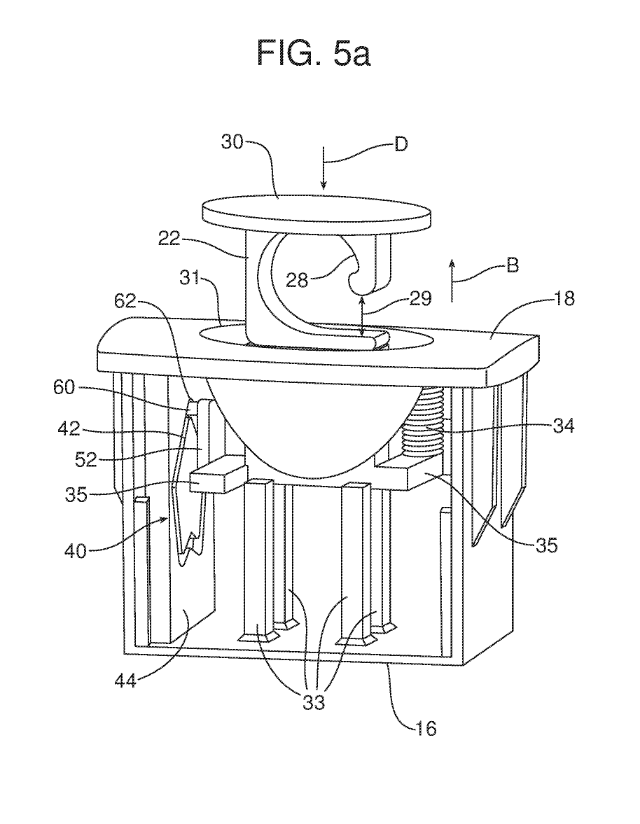

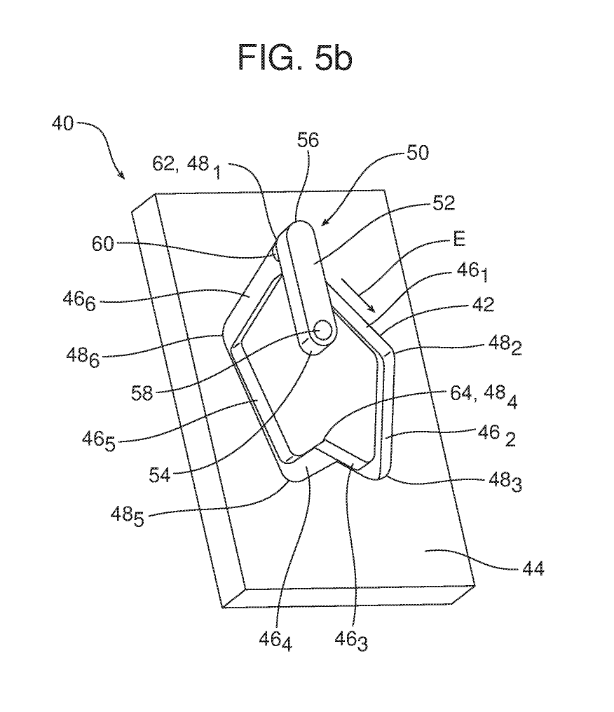

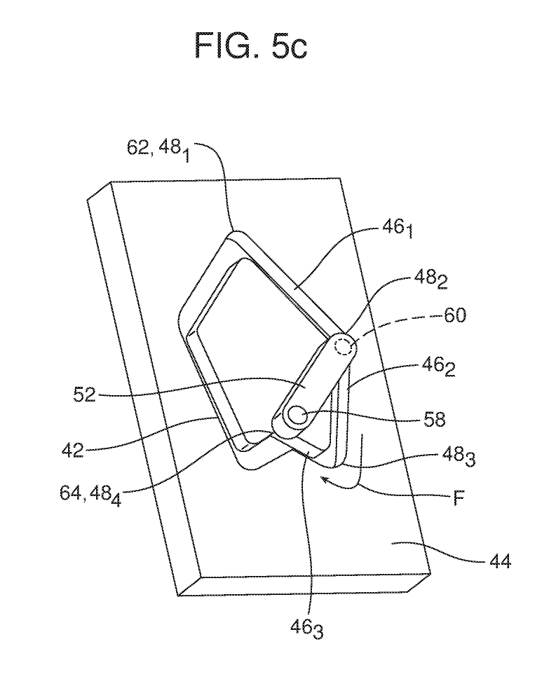

As best illustrated in FIGS. 5a-5c and 6a-6c, the apparatus 10 also includes a guide feature generally designated by reference numeral 40, for guiding the wiring support 14 between the home position and the deployed position. The guide feature 40 includes a guide track 42 carried on a sidewall 44 of the main body 16 of the housing 12. In the illustrated embodiment, the guide track 42 is continuous. Further, the guide track 42 includes six sides 461-466 and six vertices 481-486. As further illustrated in FIGS. 5b, 5c, 6b and 6c, the guide track 42 of the illustrated embodiment is chevron shaped.

As further illustrated in FIGS. 5a-5c and 6a-6c, the guide feature 40 also includes a guide track follower 50. The guide track follower 50 includes a link arm 52 having a first end 54 and a second end 56. The first end 54 of the link arm 52 is pivotally connected to the wiring support 14 and, more particularly, the base 20 of the wiring support, by a pivot pin 58. The second end 56 of the link arm 52 holds a guide track pin 60 that is received by and follows the guide track 42.

When the wiring support 14 is in the deployed position illustrated in FIG. 5a, the guide track pin 60 is located in the guide track 42 at the first vertex 48₁ which forms a first peak 62 of the guide track. When the wiring support 14 is in the home position illustrated in FIG. 6a, the guide track pin 60 is received in the guide track 42 at the fourth vertex 48₄ which forms a second peak 64 of the guide track.

When the wiring support 14 is in the deployed position illustrated in FIG. 5a, the biasing element 34 functions to bias the wiring support in the direction of action arrow B maintaining the guide track pin 60 at the top of the first peak 62. When one wishes to displace the wiring support from the deployed position illustrated in FIG. 5a to the home position illustrated in FIG. 6a, one removes the charge cable C from the wire receiving aperture 28 and reorients the head 30 into alignment with the aperture 31 in the bezel 18 by twisting the clip 22 in the base 20. Next, one engages the head 30 and presses downward in the direction of action arrow D against the force of the biasing element 34. As the wiring support 14 is displaced toward the home position, the guide track pin 60 follows the guide track 42 passing down the first side 46₁ of the guide track to the second vertex 48₂ (note action arrow E in FIG. 5b) and then down along the second side 46₂ of the guide track and past the third vertex 48₃. Upon releasing the head 30 of the wiring support 14, the biasing element 34 biases the wiring support so that the head is received in the opening 31 of the bezel and fits flush with the surface of the bezel. Simultaneously, the guide track pin 60 passes along side 46₃ of the guide track 42 and is displaced to the second peak 64 at the vertex 48₄. Note action arrow F in FIG. 5c.

When one wishes to displace the wiring support 14 from the home position illustrated in FIG. 6a to the deployed position illustrated in FIG. 6b, one again engages the head 30 of the wiring support 14 and presses downward in the direction of action arrow G against the force of the biasing element in the direction of action arrow H. As the wiring support 14 is depressed into the housing 12, the guide track pin 60 moves along the fourth side 46₄ of the guide track 42 to the fifth vertex 48₄ (note action arrow I in FIG. 6b). Upon releasing the head 30, the biasing element 34 then biases the wiring support upward in the direction of action arrow H and the guide track pin 60 passes along the fifth side 46₅ of the guide track 42 past the sixth vertex 48₆ and then along the sixth side 46₆ of the guide track to the first vertex 48₁. Note action arrow J in FIG. 6b. The biasing force of the biasing element 34 then maintains the wiring support in the deployed position with the guide track pin 60 at the first peak 62 formed by the first vertex 48₁ (again see FIG. 5b and FIG. 5a).

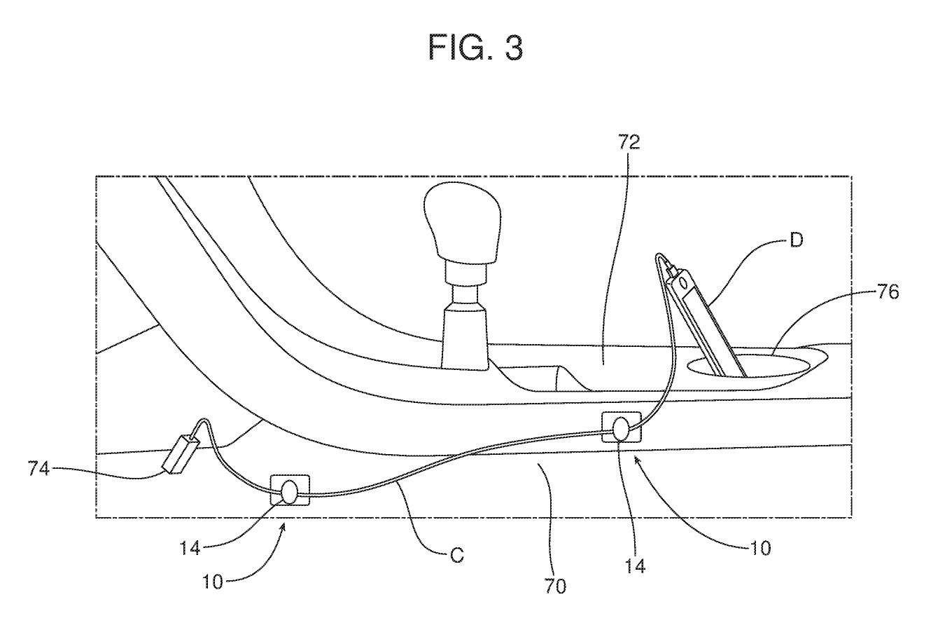

The apparatus 10 may be provided in substantially any location inside the passenger compartment of a motor vehicle where charge cord or wire management would be of benefit. For example, as illustrated in FIG. 3, two of the apparatus 10 are provided along the side 70 of the center console 72. More specifically, as illustrated in FIG. 3, the wiring support 14 of each apparatus 10 are in the deployed position and holding a charge cord C that extends from the utility power outlet 74 to the electronic device D held in a cup or pocket 76 in the top of the center console 72.

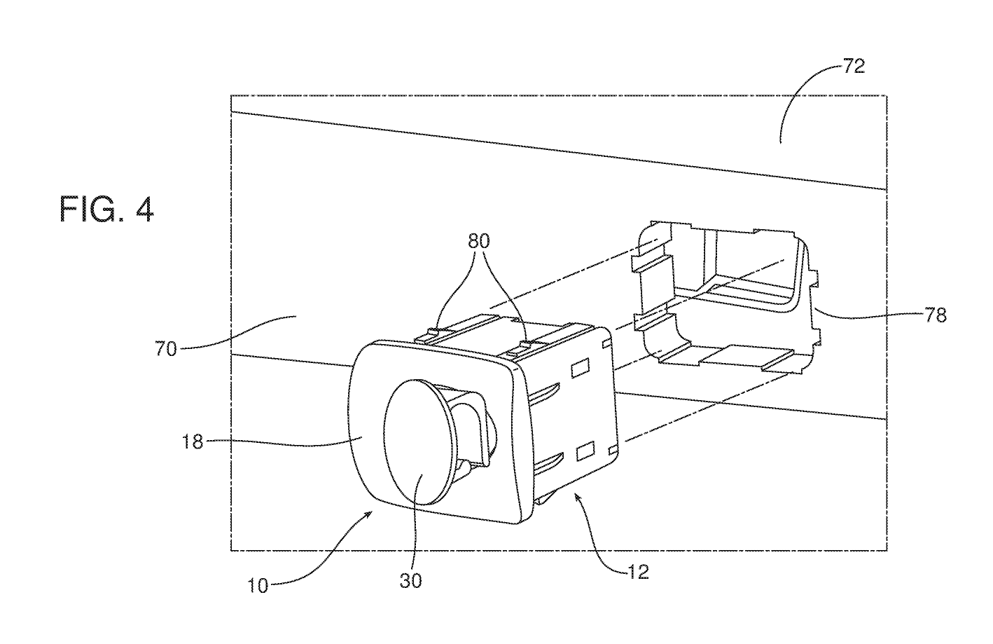

As illustrated in FIG. 4, the apparatus 10 is easily mounted in position along the side 70 of a center console 72. More specifically, the side 70 is provided with a notched receiver 78 sized and shaped to receive the housing 12 of the apparatus 10. Mounting tabs or lugs 80 on the side of the housing 12 engage the margin of the side 70 that define the notched receiver 78 to secure the housing 12 in position. The bezel 18 laps the margin and provides an aesthetically pleasing appearance.

FIGS. 3 and 4 illustrate just one possible application wherein the apparatus 10 is mounted to the side 70 of a center console 72. It should be appreciated, however, that the apparatus 10 may be mounted along the top of the center console 72 or at other locations in the motor vehicle including, for example, along substantially any trim panel located in the vehicle where wiring or charge cable management might be desired.

The foregoing has been presented for purposes of illustration and description. It is not intended to be exhaustive or to limit the embodiments to the precise form disclosed. Obvious modifications and variations are possible in light of the above teachings. For example, the guide feature 40 may include a second guide track 42 and a second guide track follower 50 at the opposite side of the apparatus 10 that would be hidden from view in the drawing figures. Further, the head 30 and the bezel 18 may be adapted or shaped to match the surface of the trim panel into which the apparatus 10 is to be inserted. All such modifications and variations are within the scope of the appended claims when interpreted in accordance with the breadth to which they are fairly, legally and equitably entitled.

1. An apparatus, comprising:
a housing; and
a wiring support carried on said housing and displaceable between a retracted home position and an extended deployed position, said wiring support including a base and a clip wherein said clip is connected to said base by a pin, said pin being carried on said clip and received in a socket carried on said base, said pin and said socket allowing said clip to be rotated with respect to said base; and
a biasing element biasing said wiring support toward said deployed position.

2. (canceled)

3. The apparatus of claim 1, wherein said housing further includes a main body and a bezel.

4. (canceled)

5. (canceled)

6. The apparatus of claim 1, further including a guide feature for guiding said wiring support between said home position and said deployed position.

7. The apparatus of claim 6, wherein said guide feature includes a guide track carried on said housing:

8. The apparatus of claim 7, wherein said guide feature includes a guide track follower,

9. The apparatus of claim 8, wherein said guide track follower includes a link arm having a first end and a second end.

10. The apparatus of claim 9, wherein said first end of said link arm is pivotally connected to said wiring support by a pivot pin.

11. The apparatus of claim 10, wherein said second end of said link arm holds a guide track pin that is received by and follows said guide track.

12. The apparatus of claim 11, wherein said guide track is continuous.

13. The apparatus of claim 2, wherein said guide track includes six sides and six vertices.

14. (canceled)

15. The apparatus of claim 11, wherein said guide track pin is positioned at said first peak when said wiring support is in said home position.

16. The apparatus of claim 15, wherein said guide track pin is positioned at said second peak when said wiring support is in said deployed position.

17. The apparatus of claim 2, further including a guide feature for guiding said wiring support between said home position and said deployed position.

18. The apparatus of claim 17, wherein said guide feature includes a guide track carried on said housing.

19. The apparatus of claim 18, wherein said guide feature includes a guide track follower having (a) a link arm with a first end and a second end, (b) a pivot pin connecting said first end to said wiring support and (c) a guide track pin that is received by and follows said guide track.

20. (canceled)
